(19) United States
(12) Patent Application Publication
(10) Pub. No.: US 2009/0101870 A1
(43) Pub. Date: Apr. 23, 2009

(54) ELECTRON TRANSPORT BI-LAYERS AND DEVICES MADE WITH SUCH BI-LAYERS

(75) Inventors: Shiva Prakash, Santa Barbara, CA (US); Jonathan M. Ziebarth, Santa Barbara, CA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/255,242

(22) Filed: Oct. 21, 2008

Related U.S. Application Data
(60) Provisional application No. 60/981,619, filed on Oct. 22, 2007.

(51) Int. Cl. C09K 11/02; C09K 11/06

(52) U.S. Cl. 252/301.35; 252/301.16

(57) ABSTRACT

There are disclosed bi-layer compositions which are useful as electron transport layers. The bi-layers have a first layer containing electron transport material and a second layer containing a fullerene. Also disclosed are organic light emitting diodes including the electron transport bi-layers.

### BACKGROUND INFORMATION

1. Field of the Disclosure

This disclosure relates in general to electron transport bi-layers, which are useful in electronic devices.

2. Description of the Related Art

Organic electronic devices define a category of products that include an active layer. Such devices convert electrical energy into radiation, detect signals through electronic processes, convert radiation into electrical energy, or include one or more organic semiconductor layers.

Organic light-emitting diodes (OLEDs) are an organic electronic device comprising an organic layer capable of electroluminescence (“EL”). OLEDs containing conducting polymers can have the following configuration:
anode/EL material/cathode

The anode is typically any material that is transparent and has the ability to inject holes into the EL material, such as, for example, indium/tin oxide (ITO). The anode is optionally supported on a glass or plastic substrate. EL materials include fluorescent compounds, fluorescent and phosphorescent metal complexes, conjugated polymers, and mixtures thereof. The cathode is typically any material (such as, e.g., Ca or Ba) that has the ability to inject electrons into the EL material.

One or more layers may be present between the EL material and the anode and/or cathode. These layers are present primarily for the purpose of charge transport, although they may serve other functions as well. The overall forward biased voltage of the OLED diode is dependent on the voltage dropped across each layer. Raising the power efficiency of the device is contingent upon lowering the voltage drop across each layer without sacrificing electroluminescence. The electron transport layer between the EL layer and the cathode, may be one such layer which suffers a large voltage drop. There is a need, therefore, for an electron transport layer which would suffer a significantly lower voltage drop, thereby increasing the power efficiency of the OLED device.

### SUMMARY

There is provided an electron transport bi-layer comprising at least one first layer comprising electron transport material and a second layer comprising a fullerene.

There is also provided an electronic device comprising an anode, a photoactive layer, and a cathode, wherein the above electron transport bi-layer is between the photoactive layer and the cathode.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented in this disclosure.

FIG. 1 is a schematic diagram of an organic electronic device.

FIG. 2 is a graph of OLED device voltage as a function of fullerene concentration, for red EL material.

FIG. 3 is a graph of OLED device voltage as a function of fullerene concentration, for green EL material.

FIG. 4 is a graph of OLED device voltage as a function of fullerene concentration, for blue EL material.

Skilled artisans will appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

Many aspects and embodiments have been described above and are merely exemplary and not limiting. After reading this specification, skilled artisans will appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Electron Transport Bi-layer, Electronic Devices, and finally Examples.

### 1. Definitions and Clarification of Terms

Before addressing details of embodiments described below, some terms are defined or clarified.

The term “charge transport” is intended to mean when referring to a layer, material, member or structure, such a layer, material, member or structure that promotes or facilitates migration of charges through such a layer, material, member or structure into another layer, material, member or structure. Although some photoactive or electroactive materials may also have charge transport properties, the term “charge transport” is not intended to include materials whose primary function is light emission or light absorption.

The term “electron transport” refers to charge transport with respect to negative charges.

The term “hole transport” refers to charge transport with respect to positive charges.

The term “fullerene” refers to cage-like, hollow molecules composed of hexagonal and pentagonal groups of carbon atoms. In some embodiments, there are at least 60 carbon atoms present in the molecule.

The term “layer” is used interchangeably with the term “film” and refers to a coating covering a desired area. The term is not limited by size. The area can be as large as an entire device or as small as a specific functional area such as the actual visual display, or as small as a single sub-pixel.

The term “bi-layer” refers to a functional layer in a device which is made up of at least two layers with different compositions.

The term “electroactive” when referring to a layer or material is intended to mean a layer or material that exhibits electronic or electro-radiative properties. An electroactive layer material may emit radiation or exhibit a change in concentration of electron-hole pairs when receiving radiation.

The term “photoactive” refers to a material that emits light when activated by an applied voltage (such as in an OLED or chemical cell) or responds to radiant energy and generates a signal with or without an applied bias voltage (such as in a photodetector).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{th} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. Electron Transport Bi-Layer

The electron transport bi-layer has a first layer which comprises electron transport material and a second layer which comprises a fullerene. In some embodiments, the bi-layer has a total thickness in the range of 5-200 nm; in some embodiments 10-100 nm.

a. Electron Transport Material

In the first layer of the electron transport bi-layer, any conventional electron transport material can be used. Such materials are well known in the field of OLEDs. Examples of electron transport materials include, but are not limited to, metal chelated oxinoid compounds, such as bis(2-methyl-8-quinolinolato)(para-phenyl-phenolato)aluminum(II) (BAlQ), tris(8-hydroxyquinolato)aluminum (Alq₃), and tetrakis(8-hydroxyquinolato)-aluminum (ZrQ); azole compounds such as 2-(4-biphenylyl)-5-(4-t-butylphenyl)-1,3,4-oxadiazole (PB D), 3-(4-biphenylyl)-4-phenyl-5-(4-t-butylphenyl)-1,2,4-triazole (TAZ), and 1,3,5-tri(phenyl-2-benzimidazole)benzene (TPBI); quinoxaline derivatives such as 2,3-bis(4-fluorophenyl)quinoxaline; phenanthroline derivatives such as 9,10-diphenylphenanthroline (DPA) and 2,9-dimethyl-4,7-diphenyl-1,10-phenanthroline (DDPA); and mixtures thereof.

In some embodiments, the electron transport material is selected from the group consisting of BAlQ, Alq₃, ZrQ, and combinations thereof.

In some embodiments, the first layer is a single layer. In some embodiments, the first layer is made up of two or more layers having the same or different composition.

The first layer of the electron transport bi-layer can be formed by any conventional deposition technique, including vapor deposition, liquid deposition (continuous and discontinuous techniques), and thermal transfer. Continuous liquid deposition techniques, include but are not limited to, spin coating, gravure coating, curtain coating, dip coating, slot-die coating, spray coating, and continuous nozzle coating. Discontinuous liquid deposition techniques include, but are not limited to, ink jet printing, gravure printing, and screen printing.

In some embodiments, the first layer is formed as an overall layer. In some embodiments, the first layer is formed in a pattern.

In some embodiments, the first layer of the electron transport bi-layer is thinner than the second layer. In some embodiments, the first layer has a thickness in the range of 2-100 nm; in some embodiments, 5-50 nm.

b. Fullerene

The second layer of the electron transport layer comprises a fullerene. Fullerenes are an allotrope of carbon characterized by a closed-cage structure consisting of an even number of three-coordinate carbon atoms devoid of hydrogen atoms. The fullerenes are well known and have been extensively studied.

Examples of fullerenes include C60, C60-PCMB, and C70, shown below,

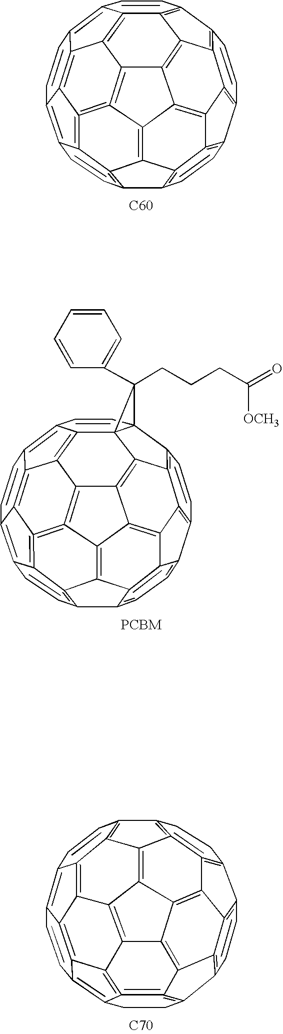

as well as C84 and higher fullerenes. Any of the fullerenes may be derivatized with a (3-methoxycarbonyl)-propyl-1-phenyl group (“PCBM”), such as C70-PCBM, C84-PCBM, and higher analogs. Combinations of fullerenes can be used.

In some embodiments, the fullerene is selected from the group consisting of C60, C60-PCMB, C70, C70-PCMB, and combinations thereof.

The second layer of the electron transport bi-layer can be formed by any conventional deposition technique, including vapor deposition, liquid deposition (continuous and discontinuous techniques), and thermal transfer, as discussed above.

In some embodiments, the second layer overlies the first layer, but does not extend beyond the first layer. When the first layer of the electron transport bi-layer is formed overall, the second layer can also be formed as an overall layer or it can be formed in a pattern. When the first layer is formed in a pattern, the second layer is formed in a pattern coincident with the first layer pattern.

In some embodiments, the second layer of the electron transport bi-layer has a thickness in the range of 3-150 nm; in some embodiments, 10-100 nm.

### 3. Electronic Devices

There are provided electronic devices comprising at least one electroactive layer positioned between two electrical contact layers, wherein the device further includes the new electron transport bi-layer.

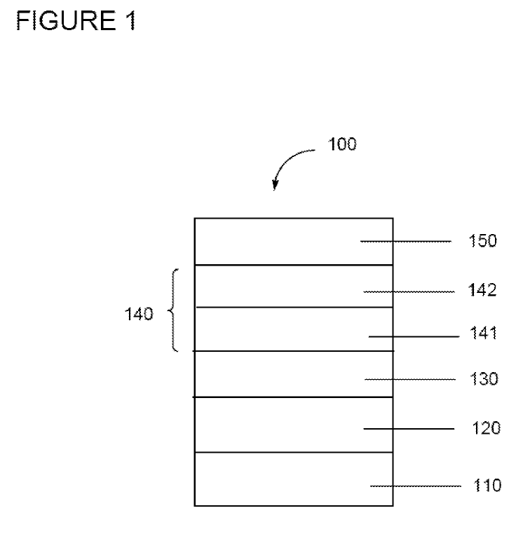

As shown in FIG. 1, a typical device, 100, has an anode layer 110, a buffer layer 120, an electroactive layer 130, an electron transport bi-layer 140, and a cathode layer 150. The bi-layer 140 has a first layer 141 comprising hole transport material. The bi-layer 140 has a second layer 142 comprising a fullerene. The fullerene layer 142 is adjacent the cathode 150.

The device may include a support or substrate (not shown) that can be adjacent to the anode layer 110 or the cathode layer 150. Most frequently, the support is adjacent the anode layer 110. The support can be flexible or rigid, organic or inorganic. Examples of support materials include, but are not limited to, glass, ceramic, metal, and plastic films.

The anode layer 110 is an electrode that is more efficient for injecting holes compared to the cathode layer 150. The anode can include materials containing a metal, mixed metal, alloy, metal oxide or mixed oxide. Suitable materials include the mixed oxides of the Group 2 elements (i.e., Be, Mg, Ca, Sr, Ba, Ra) (are these anode materials?), the Group 11 elements, the elements in Groups 4, 5, and 6, and the Group 8-10 transition elements. If the anode layer 110 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 110 include, but are not limited to, indium-tin-oxide (“ITO”), indium-zinc-oxide, aluminum-tin-oxide, gold, silver, copper, and nickel. The anode may also comprise an organic material, especially a conducting polymer such as polyaniline, including exemplary materials as described in “Flexible light-emitting diodes made from soluble conducting polymer,” Nature vol. 357, pp 477 479 (11 Jun. 1992). At least one of the anode and cathode should be at least partially transparent to allow the generated light to be observed.

The anode layer 110 may be formed by a chemical or physical vapor deposition process or spin-cast process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include rf magnetron sputtering and inductively-coupled plasma physical vapor deposition (“ICP-PVD”). These deposition techniques are well known within the semiconductor fabrication arts.

In one embodiment, the anode layer 110 is patterned during a lithographic operation. The pattern may vary as desired. The layers can be formed in a pattern by, for example, positioning a patterned mask or resist on the first flexible composite barrier structure prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used.

The buffer layer 120 comprises buffer material. The term “buffer layer” or “buffer material” is intended to mean electrically conductive or semiconductive materials and may have one or more functions in an organic electronic device, including but not limited to, planarization of the underlying layer, charge transport and/or charge injection properties, scavenging of impurities such as oxygen or metal ions, and other aspects to facilitate or to improve the performance of the organic electronic device.

The buffer material can be a polymeric material, such as polyaniline (PANI) or polyethylenedioxythiophene (PEDOT), which are often doped with protonic acids. The protonic acids can be, for example, poly(styrenesulfonic acid), poly(2-acrylamido-2-methyl-1-propanesulfonic acid), and the like. The buffer layer 120 can comprise charge transfer compounds, and the like, such as copper phthalocyanine and the tetrathiafulvalene-tetracyanoquinodimethane system (TTF-TCNQ). In one embodiment, the buffer layer 120 is made from a dispersion of a conducting polymer and a colloid-forming polymeric acid. In some embodiments, the colloid-forming polymeric acid is a fluorinated sulfonic acid. Such materials have been described in, for example, published U.S. patent applications 2004-0102577 and 2004-0127637.

The buffer layer is usually deposited onto substrates using a variety of techniques well-known to those skilled in the art. Typical deposition techniques, as discussed above, include vapor deposition, liquid deposition (continuous and discontinuous techniques), and thermal transfer.

An optional layer, not shown, may be present between the buffer layer 120 and the electroactive layer 130. This layer may comprise hole transport materials. Examples of hole transport materials have been summarized for example, in Kirk-Othmer Encyclopedia of Chemical Technology, Fourth Edition, Vol. 18, p. 837-860, 1996, by Y. Wang. Both hole transporting molecules and polymers can be used. Commonly used hole transporting molecules include, but are not limited to: 4,4′,4″-tris(N,N-diphenyl-amino)-triphenylamine (TDATA); 4,4′,4″-tris(N-3-methylphenyl-N-phenyl-amino)-triphenylamine (MTDATA); N,N′-diphenyl-N,N′-bis(3-methylphenyl)-[1,1′-biphenyl]-4,4′-diamine (TPD); 1,1-bis[(di-4-tolylamino)phenyl]cyclohexane (TAPC); N,N′-bis(4-methylphenyl)-N,N′-bis(4-ethylphenyl)-[1,1′-(3,3′-dimethyl)biphenyl]-4,4′-diamine (ETPD); tetrakis-(3-methylphenyl)-N,N,N′,N′-2,5-phenylenediamine (PDA); α-phenyl-4-N,N-diphenylaminostyrene (TPS); p-(diethylamino)benzaldehyde diphenylhydrazone (DEH); triphenylamine (TPA); bis[4-(N,N-diethylamino)-2-methylphenyl](4-methylphenyl)methane (MPMP); 1-phenyl-3-[p-(diethylamino)styryl]-5-[p-(diethylamino)phenyl]pyrazoline (PPR or DEASP); 1,2-trans-bis(9H-carbazol-9-yl)cyclobutane (DCZB); N,N,N′,N′-tetrakis(4-methyl-phenyl)-(1,1′-biphenyl)-4,4′-diamine (TTB); N,N′-bis(naphthalen-1-yl)-N,N′-bis-(phenyl)benzidine (α-NPB); and porphyrinic compounds, such as copper phthalocyanine. Commonly used hole transporting polymers include, but are not limited to, polyvinylcarbazole, (phenylmethyl)polysilane, poly(dioxythiophenes), polyanilines, and polypyrroles. It is also possible to obtain hole transporting polymers by doping hole transporting molecules such as those mentioned above into polymers such as polystyrene and polycarbonate.

Depending upon the application of the device, the electroactive layer 130 can be a light-emitting layer that is activated by an applied voltage (such as in a light-emitting diode or light-emitting electrochemical cell), a layer of material that responds to radiant energy and generates a signal with or without an applied bias voltage (such as in a photodetector). In one embodiment, the electroactive material is an organic electroluminescent (“EL”) material. Any EL material can be used in the devices, including, but not limited to, small molecule organic fluorescent compounds, fluorescent and phosphorescent metal complexes, conjugated polymers, and mixtures thereof. Examples of fluorescent compounds include, but are not limited to, pyrene, perylene, rubrene, coumarin, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of iridium with phenylpyridine, phenylquinoline, or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof. Electroluminescent emissive layers comprising a charge carrying host material and a metal complex have been described by Thompson et al., in U.S. Pat. No. 6,303,238, and by Burrows and Thompson in published PCT applications WO 00/70655 and WO 01/41512. Examples of conjugated polymers include, but are not limited to poly(phenylenevinylenes), polyfluorenes, poly(spirobifluorenes), polythiophenes, poly(p-phenylenes), copolymers thereof, and mixtures thereof.

The electron transport bi-layer 140 is usually deposited onto substrates using a variety of techniques well-known to those skilled in the art. Typical deposition techniques, as discussed above, include vapor deposition, liquid deposition (continuous and discontinuous techniques), and thermal transfer.

An optional layer, not shown, may be present between the electron transport bi-layer 140 and the cathode 150. This optional layer may be inorganic and comprise BaO, LiF, Li₂O, or the like.

The cathode layer 150 is an electrode that is particularly efficient for injecting electrons or negative charge carriers. The cathode layer 150 can be any metal or nonmetal having a lower work function than the first electrical contact layer (in this case, the anode layer 110). As used herein, the term “lower work function” is intended to mean a material having a work function no greater than about 4.4 eV. As used herein, “higher work function” is intended to mean a material having a work function of at least approximately 4.4 eV.

Materials for the cathode layer can be selected from alkali metals of Group 1 (e.g., Li, Na, K, Rb, Cs,), the Group 2 metals (e.g., Mg, Ca, Ba, or the like), the Group 12 metals, the lanthanides (e.g., Ce, Sm, Eu, or the like), and the actinides (e.g., Th, U, or the like). Materials such as aluminum, indium, yttrium, and combinations thereof, may also be used. Specific non-limiting examples of materials for the cathode layer 150 include, but are not limited to, barium, lithium, cerium, cesium, europium, rubidium, yttrium, magnesium, samarium, and alloys and combinations thereof.

The cathode layer 150 is usually formed by a chemical or physical vapor deposition process. In some embodiments, the cathode layer will be patterned, as discussed above in reference to the anode layer 110.

Other layers in the device can be made of any materials which are known to be useful in such layers upon consideration of the function to be served by such layers.

In some embodiments, an encapsulation layer (not shown) is deposited over the contact layer 150 to prevent entry of undesirable components, such as water and oxygen, into the device 100. Such components can have a deleterious effect on the organic layer 130. In one embodiment, the encapsulation layer is a barrier layer or film. In one embodiment, the encapsulation layer is a glass lid.

Though not depicted, it is understood that the device 100 may comprise additional layers. Other layers that are known in the art or otherwise may be used. In addition, any of the above-described layers may comprise two or more sub-layers or may form a laminar structure. Alternatively, some or all of anode layer 110 the hole transport layer 120, the electron transport layer 140, cathode layer 150, and other layers may be treated, especially surface treated, to increase charge carrier transport efficiency or other physical properties of the devices. The choice of materials for each of the component layers is preferably determined by balancing the goals of providing a device with high device efficiency with device operational lifetime considerations, fabrication time and complexity factors and other considerations appreciated by persons skilled in the art. It will be appreciated that determining optimal components, component configurations, and compositional identities would be routine to those of ordinary skill of in the art.

In one embodiment, the different layers have the following range of thicknesses: anode 110, 500-5000 Å, in one embodiment 1000-2000 A; buffer layer 120, 50-2000 Å, in one embodiment 200-1000 Å; photoactive layer 130, 10-2000 Å, in one embodiment 100-1000 Å; optional electron transport layer 140, 50-2000 Å, in one embodiment 100-1000 Å; cathode 150, 200-10000 Å, in one embodiment 300-5000 Å. The location of the electron-hole recombination zone in the device, and thus the emission spectrum of the device, can be affected by the relative thickness of each layer. Thus the thickness of the electron-transport layer should be chosen so that the electron-hole recombination zone is in the light-emitting layer. The desired ratio of layer thicknesses will depend on the exact nature of the materials used.

In operation, a voltage from an appropriate power supply (not depicted) is applied to the device 100. Current therefore passes across the layers of the device 100. Electrons enter the organic polymer layer, releasing photons. In some OLEDs, called active matrix OLED displays, individual deposits of photoactive organic films may be independently excited by the passage of current, leading to individual pixels of light emission. In some OLEDs, called passive matrix OLED displays, deposits of photoactive organic films may be excited by rows and columns of electrical contact layers.

### EXAMPLES

The concepts described herein will be further described in the following examples, which do not limit the scope of the invention described in the claims.

### Device Fabrication

Electronic devices were made according to the following procedure. Glass substrates with a patterned ITO coating were plasma cleaned and then spun with a buffer layer and hole transport layer. The active layers were then spun from a solvent. The substrates were then taken to a vacuum chamber, where the electron transporting bi-layers were deposited through a shadow mask, followed by the electron injection layer and electrode through another mask to complete the device.

### Examples 1-2 and Comparative A

These examples illustrate the performance of an OLED device having a red-emitting EL material.

### Comparative Example A

In this comparative example, a red device was constructed, as described above, with a single electron transport layer made of ZrQ.

### Example 1

In this example, a red device was constructed using an electron transport bi-layer. The first layer was ZrQ. The second layer was C60 fullerene having a thickness of 5 nm.

### Example 2

In this example, a red device was constructed using an electron transport bi-layer. The first layer was ZrQ. The second layer was C60 fullerene having a thickness of 20 nm.

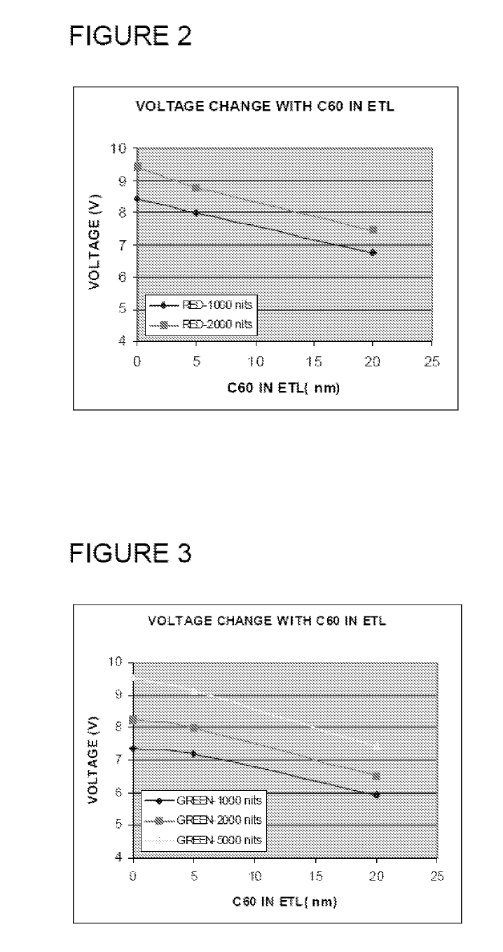

Devices from Comparative Example A (0 nm C60), Example 1 (5 nm C60), and Example 2 (20 nm C60) were tested as described in the general procedure. As shown in FIG. 2, the devices with the electron transport bi-layer required lower voltage.

### Examples 3-4 and Comparative B

These examples illustrate the performance of an OLED device having a green-emitting EL material.

### Comparative Example B

In this comparative example, a green device was constructed, as described above, with a single electron transport layer made of ZrQ.

### Example 3

In this example, a green device was constructed using an electron transport bi-layer. The first layer was ZrQ. The second layer was C60 fullerene having a thickness of 5 nm.

### Example 4

In this example, a green device was constructed using an electron transport bi-layer. The first layer was ZrQ. The second layer was C60 fullerene having a thickness of 20 nm.

Devices from Comparative Example B (0 nm C60), Example 3 (5 nm C60), and Example 4 (20 nm C60), were tested as described in the general procedure. As shown in FIG. 3, the devices with the electron transport bi-layer required lower voltage.

### Examples 5-6 and Comparative C

These examples illustrate the performance of an OLED device having a blue-emitting EL material.

### Comparative Example C

In this comparative example, a blue device was constructed, as described above, with a single electron transport layer made of ZrQ.

### Example 5

In this example, a blue device was constructed using an electron transport bi-layer. The first layer was ZrQ. The second layer was C60 fullerene having a thickness of 5 nm.

### Example 6

In this example, a blue device was constructed using an electron transport bi-layer. The first layer was ZrQ. The second layer was C60 fullerene having a thickness of 20 nm.

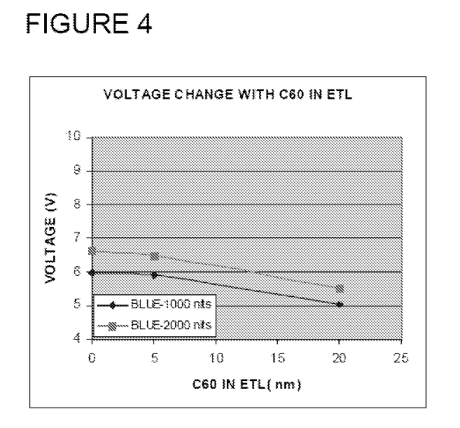

Devices from Comparative Example C (0 nm C60), Example 5 (5 nm C60), and Example 6 (20 nm C60), were tested as described in the general procedure. As shown in FIG. 4, the devices with the electron transport bi-layer required lower voltage.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. The use of numerical values in the various ranges specified herein is stated as approximations as though the minimum and maximum values within the stated ranges were both being preceded by the word “about.” In this manner slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

What is claimed is:

1. An electron transport bi-layer comprising:
a first layer comprising electron transport material; and
a second layer comprising a fullerene.

2. The electron transport bi-layer of claim 1, wherein the electron transport material is selected from the group consisting of bis(2-methyl-8-quinolinolato)(para-phenyl-phenolato)aluminum(III), tris(8-hydroxyquinolato)aluminum, tetrakis(8-hydroxyquinolato)-aluminum, and combinations thereof.

3. The electron transport bi-layer of claim 1, wherein the fullerene is selected from the group consisting of C60, C70 and C84, and combinations thereof.

4. The electron transport bi-layer of claim 1, wherein a fullerene is derivatized with a PCBM group.

5. The electron transport bi-layer of claim 1, wherein the fullerene is selected from the group consisting of C60, C61-PCBM, C70, C71-PCBM, and combinations thereof.

6. The electron transport bi-layer of claim 1, wherein the first layer is made up of two or more layers having the same or different composition.

7. The electron transport bi-layer of claim 1, wherein the bi-layer has a total thickness in the range of from 5 nm to 200 nm.

8. An organic electronic device comprising, in order, an anode, an electroactive layer, an electron transport bi-layer and a cathode, wherein the bi-layer comprises:
a first layer comprising electron transport material; and
a second layer comprising a fullerene;
and wherein the second layer is adjacent to the cathode.

9. The device of claim 8, wherein the electron transport material is selected from the group consisting of bis(2-methyl-8-quinolinolato)(para-phenyl-phenolato)aluminum(III), tris(8-hydroxyquinolato)aluminum, tetrakis(8-hydroxyquinolato)-aluminum, and combinations thereof.

10. The device of claim 8, wherein the fullerene is selected from the group consisting of C60, C70 and C84, and combinations thereof.

11. The device of claim 8, wherein a fullerene is derivatized with a PCBM group.

12. The device of claim 8, wherein the fullerene is selected from the group consisting of C60, C61-PCBM, C70, C71-PCBM, and combinations thereof.

13. The device of claim 8, further comprising a buffer layer between the anode and the electroactive layer.

14. The device of claim 13, wherein the buffer layer comprises a conducting polymer and a colloid-forming polymeric acid.

15. The device of claim 14, wherein the colloid-forming polymeric acid is fluorinated.

16. The device of claim 14, wherein the colloid-forming polymeric acid is a fluorinated sulfonic acid.

17. The device of claim 15, wherein the colloid-forming polymeric acid is perfluorinated.

18. The device of claim 16, wherein the colloid forming polymeric acid is perfluorinated.

19. The device of claim 8, wherein the first layer is made up of two or more layers having the same or different composition.

20. The device of claim 8, wherein the bi-layer has a total thickness in the range of from 5 nm to 200 nm.
